(19) United States
(12) Patent Application Publication
(10) Pub. No.: US 2018/0346259 A1
(43) Pub. Date: Dec. 6, 2018

(54) ROLLOVER SYSTEMS INCLUDING FOOT PEDAL ACTUATION

(71) Applicant: Toyota Motor Engineering & Manufacturing North America, Inc., Erlanger, KY (US)

(72) Inventor: William D. Meddings, Hurricane, WV (US)

(73) Assignee: Toyota Motor Engineering & Manufacturing North America, Inc., Erlanger, KY (US)

(21) Appl. No.: 15/612,147

(22) Filed: Jun. 2, 2017

(51) Int. Cl. B65G 47/248

(52) U.S. Cl. CPC B65G 47/248; B65G 2201/0214; B65G 2201/0223

(57) ABSTRACT

A rollover system for rolling over a part includes a rollover cylinder including at least one notch, a detent to resist the rotation of the rollover cylinder when coupled to the at least one notch, a pneumatic cylinder coupled to the detent and configured to drive the detent in a direction away from the rollover cylinder, thereby decoupling the detent from the rollover cylinder, and a foot pedal to actuate the pneumatic cylinder. Methods of rolling over parts using the rollover system and manufacturing lines including the rollover system are also described.

### TECHNICAL FIELD

The present specification generally relates to systems for rollovers of parts and, more specifically, systems for rollovers of parts which do not require manual application of large forces by a worker.

### BACKGROUND

During automotive manufacturing and/or inspection processes, large parts, such as engine blocks, may need to be inverted to access the underside of the part. Conventionally, the part may be loaded into a rollover and inverted. For the safety of workers and to ensure that the part is in place before rotation begins, rollover cages are equipped with a detent to resist rotation of the rollover cage.

In conventional systems, the worker may apply a force, such as by pushing down on the rollover cage, to compress the detent and allow the rollover to begin. In some manufacturing environments, the force required to compress the detent is 20 kgf or greater. Repeated application of these forces may create safety concerns for workers.

Accordingly, a need exists for alternative systems for rollovers of parts that do not require the manual application of large forces by a worker.

### SUMMARY

In one embodiment, a rollover system for rolling over a part may include a rollover cylinder including at least one notch, a detent to resist the rotation of the rollover cylinder when coupled to the at least one notch, a pneumatic cylinder coupled to the detent and configured to drive the detent in a direction away from the rollover cylinder, thereby decoupling the detent from the rollover cylinder, and a foot pedal to actuate the pneumatic cylinder.

In another embodiment, methods for rolling over a part may include loading the part into a rollover cylinder including a notch coupled to a detent and pressing at least one foot pedal to actuate a pneumatic cylinder effective to drive the detent in a direction away from the notch, thereby decoupling the detent from the rollover cylinder. The method may further include rotating the rollover cylinder including the part.

In yet another embodiment, a manufacturing line may include a rollover system and at least one process station coupled to the rollover system. The rollover system may include a rollover cylinder including at least one notch, a detent to resist the rotation of the rollover cylinder when coupled to the at least one notch, a pneumatic cylinder coupled to the detent and configured to drive the detent in a direction away from the rollover cylinder, thereby decoupling the detent from the rollover cylinder, and a foot pedal to actuate the pneumatic cylinder.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a rollover system according to one or more embodiments shown and described herein;

FIG. 2 depicts a side, cut-away view of the rollover system of FIG. 1 according to one or more embodiments shown and described herein;

FIG. 3 schematically depicts an example pneumatic circuit according to one or more embodiments shown and described herein; and

FIG. 4 depicts a side, cut-away view of the rollover system of FIG. 1 in which the detent is decoupled from the rollover cylinder according to one or more embodiments shown and described herein.

### DETAILED DESCRIPTION

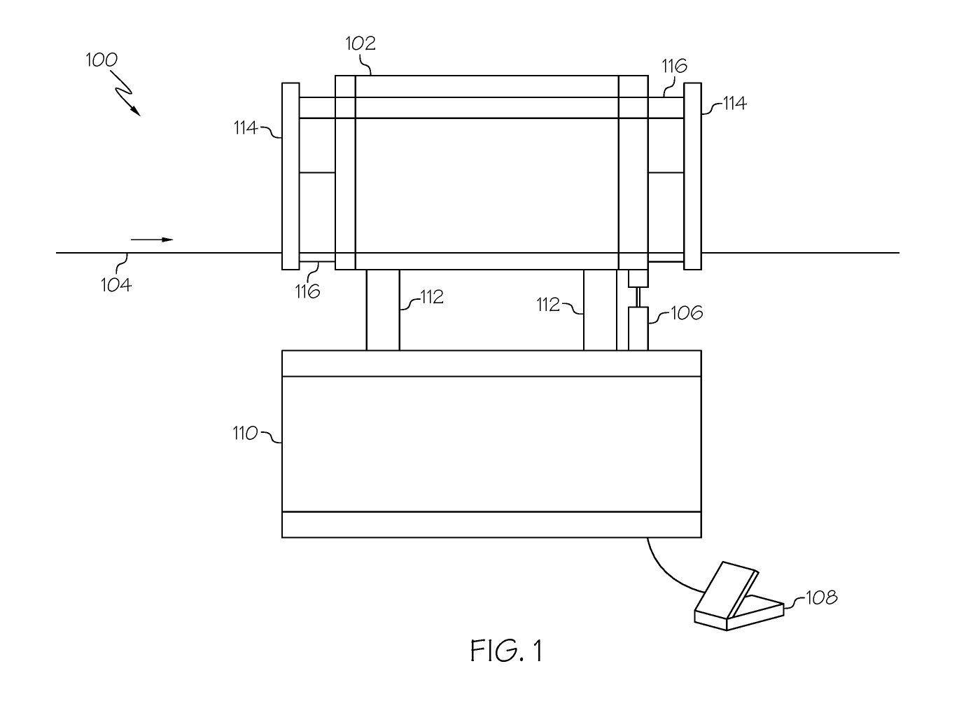

FIG. 1 generally depicts one embodiment of a rollover system for rolling over a large part. The rollover system generally includes a rollover cylinder, a detent to resist the rotation of the rollover cylinder, and a foot pedal to actuate a pneumatic cylinder effective to drive the detent in a direction away from the rollover cylinder, thereby decoupling the detent from the rollover cylinder. Various embodiments of the rollover system and the operation of the rollover system will be described in more detail herein.

Referring now to FIG. 1, an embodiment of a rollover system 100 is depicted. The rollover system 100 includes a rollover cylinder 102. In the embodiment depicted in FIG. 1, a conveyor system 104 is coupled to the rollover cylinder 102 and transports parts into and out of the rollover cylinder 102. Although the embodiment in FIG. 1 includes a conveyor system 104 extending from both sides of the rollover cylinder 102, it is contemplated that in some embodiments, the conveyor system 104 may extend only from one side of the rollover cylinder 102. For example, the conveyor system 104 may transport a part into the rollover cylinder 102, which inverts the part, and then may be reversed to transport the part out of the rollover cylinder 102. Such an embodiment may be suitable, for example, when the rollover system 100 is not part of a larger, in-line process. In still other embodiments, the rollover system 100 may not include a conveyor system 104. In such embodiments, the part may be positioned within the rollover cylinder 102 by another suitable means, such as by crane, lift truck, or the like.

The conveyor system 104 may include any conveyor system operable to facilitate the movement of parts. For example, as depicted in FIG. 1, the conveyor system 104 may include one or more conveyor belts that are each operable to transport parts. In another embodiment, the conveyor system 104 may include a plurality of rollers that allow for parts to pass over the series of rollers with reduced friction. It should be appreciated that the conveyor system 104 can include any alternative system, or combinations thereof, such that it facilitates the movement of the part into and out of the rollover cylinder 102.

The rollover cylinder 102 is supported on a machine base 110 by a pair of support shafts 112 which extend from the machine base 110. The rollover cylinder 102 includes two edge members 114 which are coupled to one another through one or more beams 116. In various embodiments, a user may grip one or both of the edge members 114 and apply a force necessary to rotate the rollover cylinder 102 about an axis extending through the rollover cylinder 102 in a direction that is substantially parallel to the conveyor system 104. In some embodiments, a mesh made of a metal or other suitable material may be used to form an outer surface of the rollover cylinder 102, although in some embodiments, the rollover cylinder 102 may be a series of beams 116 connected through the edge members 114. A mesh may, for example, provide additional security or protection for users. In still other embodiments, the rollover cylinder 102 may be defined by a solid surface extending between the two edge members 114. The solid surface may be, for example, a metal or plastic material, although other materials may be employed depending on the particular embodiment.

The rollover cylinder 102 is sized such that it can receive the part to be inverted. In some embodiments, the rollover cylinder 102 may include mounting brackets configured to secure the part to be inverted in place. For example, the rollover cylinder 102 may include two, four, six, or more mounting brackets to secure the part in place. In some embodiments, the part may be coupled to the mounting brackets using bolts, screws, or another coupling mechanism. Alternatively, the mounting brackets may be configured to couple to the part without the use of additional coupling mechanisms. For example, the mounting brackets may be in the form of clamps which secure the part in place.

In some embodiments, the rollover cylinder 102 includes a top portion and a bottom portion that are pivotally coupled to one another. For example, one or more hinges may be used to couple the top portion to the bottom portion. Accordingly, the top portion may be pivotally rotated, such as to expose the part within the rollover cylinder 102. In embodiments, the top portion may be pivoted into an open position after the part is moved into the rollover cylinder 102 by the conveyor system 104 to enable the part to be coupled to the mounting brackets. Then, the top portion may be pivoted into a closed position and secured in place, for example, using a latch or other locking mechanism, to enable the rollover cylinder 102 to be rotated. Alternatively, the top portion may be completely decoupled from the bottom portion. In such embodiments, the top portion may be lifted or decoupled from the bottom portion using a lift or other mechanism configured to accept the top portion and remove the top portion from the bottom portion. For example, a lift may be employed to lift the top portion to a predetermined height above the bottom portion to expose the part within the rollover cylinder. In such embodiments, latches or other locking mechanisms may be employed at various locations along the exterior of the rollover cylinder 102 to ensure that the top portion and the bottom portion are securely coupled together during use.

The rollover system 100 further includes a detent 106. As will be discussed in greater detail below, the detent 106 is configured to resist the rotation of the rollover cylinder 102 when it is coupled to the rollover cylinder 102. The detent 106 is coupled to a pneumatic cylinder which is configured to drive the detent in a direction away from the rollover cylinder 102, thereby decoupling the detent 106 from the rollover cylinder 102, and allowing the rollover cylinder 102 to rotate.

The detent 106 is actuated by a foot pedal 108. In various embodiments, a worker may depress the foot pedal 108, which actuates the pneumatic cylinder and drives the detent 106 in a direction away from the rollover cylinder 102. With the detent 106 decoupled from the rollover cylinder 102, the worker can then rotate the rollover cylinder 102, such as by applying force to one or both of the edge members 114, effective to invert the part within the rollover cylinder 102. As will be described in greater detail below, in some embodiments, multiple pedals may be depressed to actuate the pneumatic cylinder, while in other embodiments, a single pedal may be depressed and/or released to actuate multiple pneumatic cylinders.

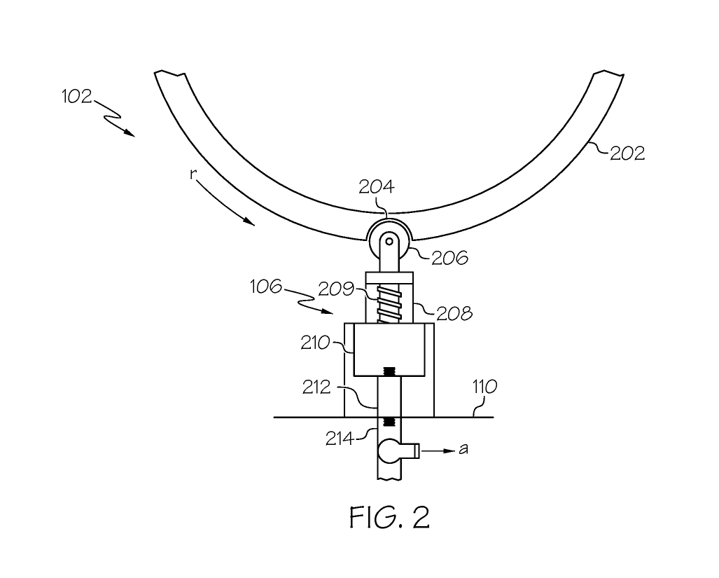

Turning now to FIG. 2, a side, cut-away view of the rollover system is depicted. As shown in FIG. 2, the rollover cylinder 102 includes a frame 202 including a notch 204 therein. The frame 202 may be used to support the mesh or solid surface of the rollover cylinder 102, as described above, or may be used to connect the series of beams 116 to form the rollover cylinder 102. Although in the figures, the notch 204 is depicted as being positioned in the frame 202, it is contemplated that in some embodiments, the notch 204 may be positioned in one of the edge members 114 or in the mesh or solid surface of the rollover cylinder 102. Regardless of its location on the rollover cylinder 102, the notch 204 has a size and shape that is substantially the inverse of the detent 106. In other words, the detent 106 and the notch 204 have complementary configurations such that when the detent 106 and the notch 204 are coupled together, the detent 106 and the notch 204 are disposed close together to prevent the rollover cylinder 102 from rotating. In particular, the detent 106 includes an outwardly projecting, or male, surface, while the notch 204 has a groove, or female, surface that is fitted to couple to the male surface of the detent 106. Other shapes and configurations for the detent 106 and the notch 204 are contemplated. For example, although the notch 204 is depicted in FIG. 2 as having a semi-circular shape, it is contemplated that the notch may have a triangular shape, a square shape, or any other shape suitable for receiving the detent 106.

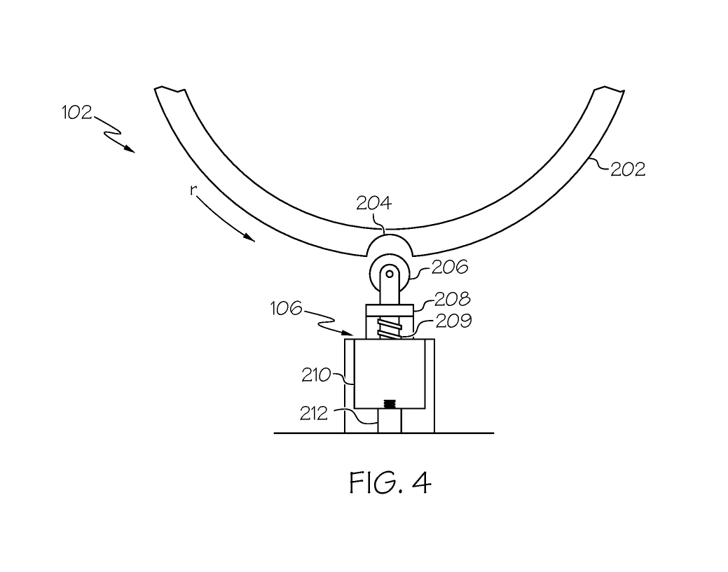

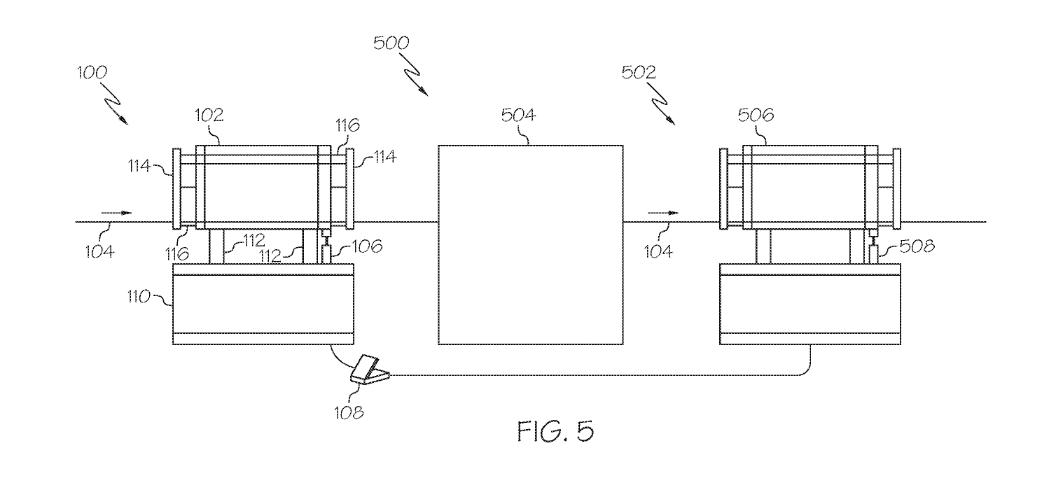

In various embodiments, the male surface of the detent 106 is in the form of a wheel 206 that is rotatably coupled to a shaft 208 that is configured to move toward and away from the rollover cylinder 102. Accordingly, when the detent 106 is decoupled from the rollover cylinder 102 (as shown in FIG. 4), the male surface of the detent 106 may come into contact with the surface of the rollover cylinder 102 and rotate to enable the rollover cylinder 102 to pass over the detent 106. For example, when the rollover cylinder 102 is rotated in the direction r as shown in FIG. 2, the male surface of the detent 106 may rotate in a clockwise direction in contact with the rollover cylinder 102.

The shaft 208 is coupled to a passive resistance mechanism 209. As used herein, the phrase “passive resistance mechanism” refers to any resistance mechanism that resists the motion of the detent 106 from a nominal position without actively moving the detent 106. For example, the passive resistance mechanism may be in the form of one or more air springs, coil springs, elastically deformable resistance bands, or the like. In particular embodiments, the passive resistance mechanism 209 is a spring. The passive resistance mechanism 209 is coupled to the shaft 208, and resists a motion of the shaft 208 in a direction away from the rollover cylinder 102, thus providing a passive mechanical resistance to the rollover cylinder 102 coupled to the detent 106. The passive resistance mechanism 209 generally biases the detent 106 towards the rollover cylinder 102, and resists transitioning the detent 106 from a position in which the detent 106 is coupled to the rollover cylinder 102 via the notch 204 to a compressed position in which the detent 106 is decoupled from the rollover cylinder 102 and is retracted away from the rollover cylinder 102 with a biasing force B.

The shaft 208 is connected to a drive shaft 212 through a shaft guide 210. Although depicted in FIGS. 2 and 4 as being separate shafts that are coupled together, it is contemplated that the shaft 208 and the drive shaft 212 may be opposing ends of a single shaft. The shaft guide 210 is configured to receive the shaft 208 as it is pulled in a direction away from the rollover cylinder 102. In some embodiments, the shaft guide 210 provides a surface effective to compress the passive resistance mechanism 209 as the shaft 208 is driven. Alternatively, the shaft guide 210 may be a substantially hollow cylinder or box having open opposing ends to enable the shaft 208 and the drive shaft 212 to easily pass through.

The detent 106 is further coupled to a pneumatic cylinder 214. The pneumatic cylinder 214 is configured to drive the detent 106 in a direction away from the rollover cylinder 102, as shown in FIG. 4. Specifically, the pneumatic cylinder 214 pulls the drive shaft 212 in a downward direction, compressing the passive resistance mechanism 209, thereby decoupling the detent 106 from the notch 204 of the rollover cylinder 102. The pneumatic cylinder 214 may include a piston that is affixed to the detent 106 and a cylinder affixed to the machine base 110 or another non-moveable portion of the rollover assembly. The pneumatic cylinder 214 may a spring-loaded single acting pneumatic cylinder, or a double acting pneumatic cylinder. In FIG. 2, the pneumatic cylinder 214 is depicted in a retracted position, meaning that the piston inside the pneumatic cylinder 214 is fully retracted into the cylinder of the pneumatic cylinder 214. Alternatively, the pneumatic cylinder 214 may be in a fully extended position, in which the piston is driven to the other end of the cylinder of the pneumatic cylinder 214. When the piston, which is affixed to the detent 106, is extended, the piston moves laterally toward the machine base 110, and the detent 106 is pulled with the piston laterally down toward the machine base 110.

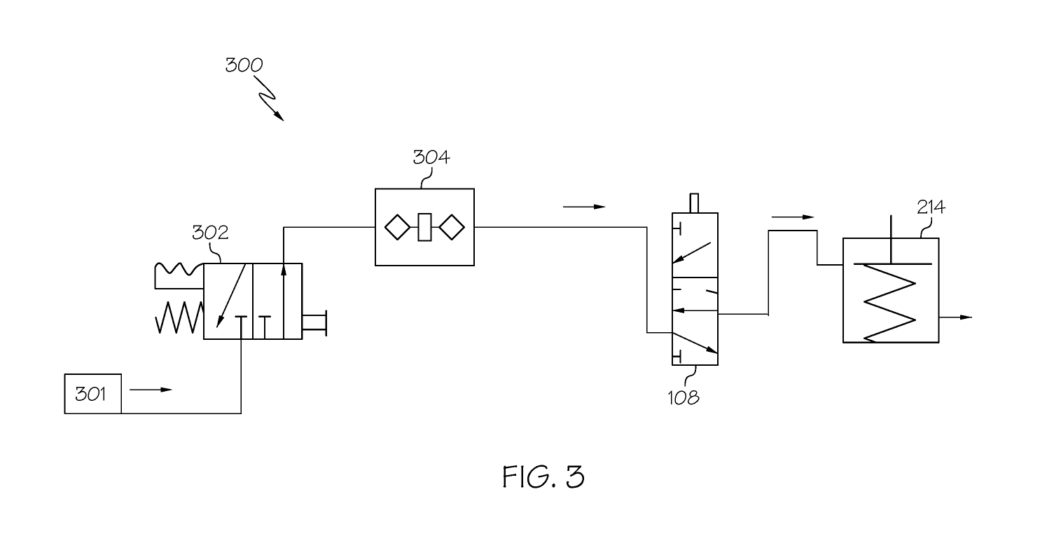

The pneumatic cylinder 214 is pneumatically connected to a pneumatic control system a, as depicted in FIG. 2. The pneumatic control system may supply air from an external air source to retract the pneumatic cylinder 214, thereby driving the detent 106 in a direction away from the rollover cylinder 102. In various embodiments, the pneumatic control system a includes a pneumatic circuit. One embodiment of a pneumatic circuit 300 for use with the pneumatic cylinder 214 is depicted in FIG. 3.

Generally, the pneumatic circuit 300 includes an air supply 301, a relief valve 302, a pressure regulator 304, the pedal 108, and the pneumatic cylinder 214. The air supply 301 is configured to supply compressed air to the pneumatic circuit. The air supply 301 may provide air, for example, from the environment or from a tank that contains air. In some embodiments, the air supply 301 may include an air intake to intake air from the environment and a compressor to compress the air into a supply of compressed air. However, it is contemplated that the air supply 301 may be of any other form known in the art.

The air supply 301 is pneumatically coupled to and provides compressed air to the relief valve 302. The relief valve 302 may provide the compressed air to the pressure regulator 304. In particular, the relief valve 302 may provide air from the air supply 301 to the pressure regulator 304 when a vent in the relief valve 302 is in a closed position. When the corresponding vent in the relief valve 302 is in an open position, the compressed air from the air supply 301 may be vented out of the system, such as back into the environment. In various embodiments, the relief valve 302 may function as a shut off valve, enabling air from the air supply 301 to be diverted from the pneumatic circuit 300. For example, the relief valve 302 may function as a safety feature, preventing the line from being accidentally recharged while a rollover is in process.

The pressure regulator 304 is pneumatically coupled to the relief valve 302 and is further pneumatically coupled to the foot pedal 108. The pressure regulator 304 enables the pneumatic circuit 300 to deliver air pressure to the pneumatic cylinder 214 different from the air pressure from the air supply 301. For example, in various embodiments, the pressure regulator 304 may provide the compressed air to the pneumatic cylinder 214 at a pressure of from about 0.3 mPa to about 0.8 mPa. In some embodiments, the pressure regulator 304 may provide the compressed air to the pneumatic cylinder 214 at a pressure of from about 0.4 mPa to about 0.7 mPa, or from about 0.5 mPa to about 0.6 mPa. It is contemplated that the air may be provided at other pressures, depending on the particular embodiment. For example, in some embodiments, the air pressure may be determined at least in part on the capabilities of the pneumatic cylinder 214 and/or the force required to collapse the spring of the detent 106.

The pressure regulator 304 adjusts the pressure of the compressed air and is pneumatically coupled to the foot pedal 108. In some embodiments, such as the embodiment depicted in FIG. 3, the pressure regulator 304 is pneumatically coupled to one foot pedal, although in other embodiments, the pressure regulator 304 may be pneumatically coupled to two or more foot pedals. For example, in some embodiments, two foot pedals are actuated in order to actuate the pneumatic cylinder. The foot pedal 108 may be any suitable type of foot pedal, including, but not limited to 3-port or 5-port pedals. In one example embodiment, the foot pedal 108 is a single actuation, dual position pedal having 3 ports. In this embodiment, the foot pedal 108 includes two “in” ports for receiving compressed air from the pressure regulator 304 and one “out” port for providing compressed air to the pneumatic cylinder 214. When the foot pedal 108 is up, or not actuated or depressed, no compressed air is provided to the pneumatic cylinder 214 and the detent 106 is coupled with the notch of the rollover cylinder 102. However, when the foot pedal 108 is down, or actuated or pressed, the “out” valve of the foot pedal 108 is opened, providing compressed air to the pneumatic cylinder 214, which drives the piston of the pneumatic cylinder 214 down and pulls the detent 106 in a direction away from the rollover cylinder 102, as shown in FIG. 4. When the foot pedal 108 is released, the “out” valve closes, and the spring in the detent 106 returns the detent 106 to an upward position, where it is in contact with the rollover cylinder 102.

Turning now to FIG. 4, an embodiment in which the detent 106 is decoupled from the rollover cylinder 102 is shown. As depicted in FIG. 4, the piston of the pneumatic cylinder 214 (not shown in FIG. 4) has been extended in a downward direction, pulling the drive shaft 212 in a downward direction, away from the rollover cylinder 102. Accordingly, the shaft 208 is pulled in a downward direction along with the drive shaft 212, compressing the passive resistance mechanism 209, and decoupling the wheel 206 of the detent 106 from the notch 204 in the frame 202 of the rollover cylinder 102. Once decoupled from the detent 106, the rollover cylinder 102 may be freely rotated in a direction r, thereby inverting the part positioned inside of the rollover cylinder 102. Although depicted in FIG. 4 as being a counter-clockwise direction, it is contemplated that the direction r may be clockwise, or counter-clockwise. In some embodiments, the rollover cylinder 102 may be freely rotated in either a clockwise or counter-clockwise direction, depending on the force applied to the rollover cylinder 102. However, it is contemplated that in some embodiments, the rollover cylinder 102 may only be rotated in a single direction to prevent injuries or accidents.

Methods of using the rollover system 100 of FIG. 1 will now be described in detail with reference to FIGS. 2-4. A part to be rolled over, such as an engine block or other part, may be placed on the conveyor system 104. The part may be placed on the conveyor system 104 by transferring the part from another conveyor system (not shown), or it may be placed on the conveyor system 104 using a crane or other machine configured to lift and move the part to a predetermined location. In various embodiments, the rollover system 100 may be one part of a larger manufacturing line, such as an automotive manufacturing line.

Once positioned on the conveyor system 104, the part is loaded into the rollover cylinder 102. For example, the conveyor system 104 may convey the part into the rollover cylinder 102. In some embodiments, the part may be secured in place and coupled to the rollover cylinder 102, such as by using mounting brackets, as described in greater detail above. As the part is loaded into the rollover cylinder 102 and secured, the rollover cylinder 102 is locked in place by the detent 106 coupled to the rollover cylinder 102. More particularly, as depicted in FIG. 2, the wheel 206 of the detent 106 rests within the notch 204 along the frame 202 of the rollover cylinder 102, thereby coupling the detent 106 to the rollover cylinder 102. When the detent 106 is coupled to the rollover cylinder 102, the rollover cylinder 102 cannot be rotated without the application of a force large enough to force the detent 106 down and decouple the detent 106 from the rollover cylinder 102.

The passive resistance mechanism 209 is in a neutral state in which the passive resistance mechanism 209 is not overly compressed, but provides enough resistance to support the wheel 206 and the rest of the shaft 208 in an upward position.

When the workers are prepared to roll over the part, the foot pedal 108 is pressed to actuate the pneumatic cylinder 214 effective to drive the detent 106 in a direction away from the notch 204 on the rollover cylinder 102. Specifically, a worker may apply a force to the foot pedal 108 by stepping onto the foot pedal 108, which causes the “out” port on the foot pedal 108 to be opened. When the “out” port on the foot pedal 108 is opened, compressed air is provided to the pneumatic circuit 300 by the air supply 301. The air passes through the relief valve 302, through the pressure regulator 304, and through the foot pedal 108 to the pneumatic cylinder 214. Actuation of the pneumatic cylinder 214 drives the piston in a downward direction to an extended position within the pneumatic cylinder 214, pulling the drive shaft 212 and the shaft 208 along with it in the downward direction. As the shaft 208 is pulled through the shaft guide 210, the passive resistance mechanism 209 is compressed, thereby decoupling the wheel 206 from the notch 204. In various embodiments, the wheel 206 is withdrawn from the notch 204 to a location at which, as the rollover cylinder 102 is rotated, the wheel 206 is in contact with the frame 202 of the rollover cylinder 102. However, in other embodiments, the wheel 206 may initially be withdrawn to a position in which it is not in contact with the rollover cylinder 102 as it is rotated, but may return to a position in contact with the rollover cylinder 102 during the rollover.

After the detent 106 is decoupled from the rollover cylinder 102, the rollover cylinder 102 is rotated. For example, the worker(s) may apply a force sufficient to rotate the rollover cylinder 102 in a direction r. As an alternative to applying the force manually, in some embodiments, the worker may actuate a machine that applies the force to rotate the rollover cylinder 102. In various embodiments, the rollover cylinder 102 is rotated approximately 180 degrees. The rotation of the rollover cylinder 102 by 180 degrees is sufficient to effect a complete inversion of the part within the rollover cylinder 102. However, it is contemplated that in some embodiments, the rollover cylinder 102 may be rotated more or less. For example, the rollover cylinder 102 may be rotated approximately 45 degrees, approximately 90 degrees, approximately 180 degrees, approximately 270 degrees, or any other amount required by the particular embodiment. Accordingly, the rollover cylinder may be rotated from about 10 degrees to about 360 degrees, including any value or range included therein.

During rotation of the rollover cylinder 102, in various embodiments, the compressed air is cut off from the pneumatic cylinder 214. For example, after a predetermined amount of compressed air has been provided to the pneumatic cylinder 214, the relief valve 302 may open, venting additional compressed air provided by the air supply 301 to the environment. Additionally or alternatively, the worker may release the foot pedal 108, closing the “out” port, and stopping the flow of compressed air to the pneumatic cylinder 214. When the pneumatic cylinder 214 is not provided with compressed air, the piston within the pneumatic cylinder 214 returns to its retracted position, and the passive resistance mechanism 209 may expand, enabling the wheel 206 to be in contact with the frame 202 of the rollover cylinder 102. In various embodiments, the rollover cylinder 102 applies a force to the wheel 206, which compresses the passive resistance mechanism 209 until the rollover cylinder 102 is rotated into a position in which a notch, such as notch 204, is adjacent to the wheel 206, coupling the wheel 206 with the notch 204, and allowing the passive resistance mechanism 209 to return to its neutral position.

It is contemplated that in various embodiments, the frame 202 of the rollover cylinder 102 may include a plurality of notches, such that the detent 106 can be coupled to the rollover cylinder to prevent rotation of the rollover cylinder 102 when the rollover cylinder 102 is in various positions. For example, the frame 202 may include two notches positioned about 180 degrees from one another such that the detent 106 may be coupled to the rollover cylinder 102 both prior to and following rotation of the rollover cylinder 102 by 180 degrees. Additional notches may be included, depending on the particular embodiments, and in particular, based at least in part on the degree to which the rollover cylinder 102 is to be rotated.

When rotation of the rollover cylinder 102 has been completed, the detent 106 may be recoupled to the rollover cylinder 102. In some embodiments, the worker(s) may remove the part from the rollover cylinder 102. For example, the worker may decouple the part from the mounting brackets and the conveyor system 104 may be used to move the part from the rollover cylinder 102. However, in some embodiments, the worker may perform one or more additional steps in the manufacturing process while the part is positioned within or near the rollover cylinder 102. For example, in embodiments in which the rollover cylinder 102 has a top portion that pivots to expose the part within the rollover cylinder 102, the part may be exposed such that the worker can continue the manufacturing process without decoupling the part from the mounting brackets. In one particular embodiment in which the part is an engine, pistons or couplings may be added to the inverted engine while the engine is coupled to the mounting brackets. Alternatively, such as when the rollover cylinder 102 is used to invert the part for inspection, at least part of the inspection may be conducted.

In various embodiments, the rollover cylinder 102 may be rotated again to invert the part back to its original position. For example, the worker may affix one or more additional parts or components and rotate the rollover cylinder 102 an additional 180 degrees to return the part to its original orientation. In some embodiments, this additional rollover may be a rotation in the same direction (r) as the first rollover, while in other embodiments, the additional rollover may be a rotation in the opposite direction as the first rollover.

As described above, once the part is positioned in its final orientation, the part may be decoupled from the mounting brackets and removed from the rollover cylinder 102 using the conveyor system 104. In various embodiments, the part may continue along a manufacturing or other process line, such as an automotive manufacturing line.

In embodiments in which the rollover system is part of a larger manufacturing line, such as an automotive manufacturing line, it is contemplated that additional features may be included. For example, in some embodiments, a manufacturing line may include two or more rollover systems. In one particular embodiment, a first rollover system may be separated from a second rollover system by a process station that is coupled to the first rollover system and the second rollover system, such as through the conveyor system. In this embodiment, the part may be positioned within the first rollover cylinder, inverted by rotating the rollover cylinder along with the part 180 degrees, and removed from the first rollover cylinder in an inverted orientation compared to the initial orientation of the part. The part may be moved to the process station, such as by using the conveyor system, where additional steps in the manufacturing process may be performed. After the additional steps have been performed, the part may be positioned within the second rollover cylinder, such as by using the conveyor system, and inverted by rotating the second rollover cylinder along with the part 180 degrees. The part, back in its initial orientation, may then be removed from the second rollover cylinder and sent along the manufacturing line to the next process station.

In this embodiment, it is contemplated that the foot pedal 108 may be connected to both the first rollover cylinder and the second rollover cylinder. In some embodiments, when the foot pedal 108 is pressed, it may decouple a detent from the first rollover cylinder and a corresponding detent from the second rollover cylinder. Accordingly, both the first and second rollover cylinders may be rotated at the same time. It is further contemplated that in some embodiments, when the detent is decoupled from the first rollover cylinder, the corresponding detent is coupled to the second rollover cylinder and when the detent is coupled to the first rollover cylinder, the corresponding detent is decoupled from the second rollover cylinder.

Alternatively, the foot pedal may have multiple positions, as described above. In such embodiments, the foot pedal may be positioned in a first position to decouple the detent from the first rollover cylinder while the corresponding detent remains coupled with the second rollover cylinder. The foot pedal may then be moved to a second position to decouple the second detent from the second rollover cylinder while the first detent is recoupled with the first rollover cylinder.

Moreover, as described above, multiple foot pedals may be used to actuate a single rollover cylinder. For example, a first worker may be positioned along a first side of the rollover cylinder while a second worker may be positioned along a second side of the rollover cylinder. In order to decouple the detent from the rollover cylinder, both the first and second workers press a corresponding foot pedal to actuate the pneumatic cylinder, thereby decoupling the detent from the rollover cylinder. Such embodiments may reduce or prevent injuries or other accidents that may occur when one worker is not prepared for rotation of the rollover cylinder.

Various embodiments described herein include rollover systems that are actuated using foot pedals to decouple a detent from a rollover cylinder. In such embodiments, the detent may be decoupled from the rollover cylinder without requiring the application of force applied by a worker, which can reduce stresses on the worker's body and may reduce or even eliminate injuries. Additionally, various embodiments contemplate the use of multiple foot pedals to decouple a detent from the rollover cylinder, ensuring that multiple workers are prepared for the rollover cylinder to be rotated. Other advantages are contemplated, and will be appreciated by those in the art.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A rollover system comprising:
a rollover cylinder comprising at least one notch;
a detent comprising a passive resistance mechanism to resist the rotation of the rollover cylinder when coupled to the at least one notch, wherein the detent is biased toward the rollover cylinder;
a pneumatic cylinder coupled to the detent and configured to drive the detent in a direction away from the rollover cylinder withdrawing the detent from the notch to a location at which, as the rollover cylinder is rotated, the detent is in contact with the rollover cylinder; and
a foot pedal to actuate the pneumatic cylinder.

2. (canceled)

3. The rollover system of claim 1, wherein the passive resistance mechanism comprises a spring.

4. The rollover system of claim 1, wherein the rollover cylinder is a first rollover cylinder, the detent is a first detent, the pneumatic cylinder is a first pneumatic cylinder, the system further comprising:
a second rollover cylinder comprising at least one notch;
a second detent comprising a passive resistance mechanism to resist the rotation of the second rollover cylinder when coupled to the at least one notch, wherein the second detent is biased toward the second rollover cylinder; and
a second pneumatic cylinder coupled to the second detent and configured to drive the second detent in a direction away from the second rollover cylinder withdrawing the second detent from the notch to a location at which, as the second rollover cylinder is rotated, the second detent is in contact with the second rollover cylinder; wherein the foot pedal further actuates the second pneumatic cylinder.

5. The rollover system of claim 4, further comprising a conveying system coupled to the first rollover cylinder and the second rollover cylinder.

6. The rollover system of claim 1, wherein the foot pedal is a first foot pedal, the system further comprising a second foot pedal to actuate the pneumatic cylinder, wherein actuation of the pneumatic cylinder by the first foot pedal and the second foot pedal drives the detent in the direction away from the rollover cylinder.

7. The rollover system of claim 1, wherein the at least one notch is positioned in a frame of the rollover cylinder.

8. The rollover system of claim 1, further comprising a conveying system for moving parts into and out of the rollover cylinder.

9. A method for rolling over a part, comprising:
loading the part into a rollover cylinder comprising a notch on the rollover cylinder coupled to a detent comprising a passive resistance mechanism, wherein the detent is biased toward the rollover cylinder;
pressing at least one foot pedal to actuate a pneumatic cylinder effective to drive the detent in a direction away from the notch on the rollover cylinder, withdrawing the detent from the notch to a location at which, as the rollover cylinder is rotated, the detent is in contact with the rollover cylinder; and
rotating the rollover cylinder including the part.

10. The method of claim 9, wherein pressing at least one foot pedal comprises pressing two foot pedals.

11. The method of claim 9, wherein rotating the rollover cylinder comprises rotating the rollover cylinder 180 degrees.

12. The method of claim 11, the notch being a first notch, wherein the rollover cylinder further comprises a second notch positioned 180 degrees from the first notch.

13. The method of claim 12, further comprising:
coupling the detent with the second notch on the rollover cylinder effective to prevent further rotation of the rollover cylinder.

14. (canceled)

15. The method of claim 9, wherein the passive resistance mechanism comprises a spring.

16. The method of claim 9, wherein loading the part into the rollover cylinder comprises placing the part on a conveyor system coupled to the rollover cylinder and moving the part into the rollover cylinder using the conveyor system.

17. A manufacturing line comprising:
rollover system comprising:
a rollover cylinder comprising at least one notch;
a detent comprising a passive resistance mechanism to resist the rotation of the rollover cylinder when coupled to the at least one notch, wherein the detent is biased toward the rollover cylinder;
a pneumatic cylinder coupled to the detent and configured to drive the detent in a direction away from the rollover cylinder, withdrawing the detent from the notch to a location at which, as the rollover cylinder is rotated, the detent is in contact with the rollover cylinder; and
a foot pedal to actuate the pneumatic cylinder; and
at least one process station coupled to the rollover system.

18. The manufacturing line of claim 17, wherein the at least one process station is coupled to the rollover system by a conveyor system.

19. The manufacturing line of claim 18, wherein the rollover system is a first rollover system, the manufacturing line further comprising a second rollover system coupled to the conveyor system, wherein the conveyor system is operable to move a part between the first rollover system, the process station, and the second rollover system.

20. (canceled)
